(19) United States
(12) Patent Application Publication
(10) Pub. No.: US 2025/0236520 A1
(43) Pub. Date: Jul. 24, 2025

(54) Coupling Claus Process with Carbon Dioxide Capture Using Gas Hydrate

(71) Applicant: Saudi Arabian Oil Company, Dhahran (SA)

(72) Inventors: Pramod Dhanaji Patil, Dhahran (SA); Anton Manakhov, Ivanovo (RU); Abdulaziz S. Qasim, Dammam (SA)

(21) Appl. No.: 18/416,547

(22) Filed: Jan. 18, 2024

(51) Int. Cl. C01B 17/04; B01D 53/00; B01D 53/14; B01D 53/52; B01D 53/62; B01D 53/77; B01D 53/96; C01B 3/50; C01B 32/50; C02F 1/20; C02F 101/10; C02F 101/16; C02F 103/36

(52) U.S. Cl. CPC C01B 17/0404; B01D 53/002; B01D 53/1425; B01D 53/1462; B01D 53/1493; B01D 53/526; B01D 53/62; B01D 53/77; B01D 53/96; C01B 3/50; C01B 32/50; C02F 1/20; B01D 2252/103; B01D 2252/204; B01D 2257/304; B01D 2257/504; C02F 2101/101; C02F 2101/16; C02F 2103/365

(57) ABSTRACT

A method of processing an acid gas is provided. The method includes: receiving, in a sulfur recovery unit (SRU), an acid gas including hydrogen sulfide (H₂S) and carbon dioxide (CO₂); performing, in the SRU, a Claus process to treat the acid gas, generating elemental sulfur and a tail gas including the CO₂ and hydrogen (H₂); compressing the tail gas; cooling the compressed tail gas; receiving water (H₂O) in a column; receiving the cool compressed tail gas in the column; maintaining, while receiving the cool compressed tail gas in the column, a pressure and a temperature inside the column such that the cool compressed tail gas reacts with the H₂O to form a gas hydrate including the CO₂ and the H₂O in the column and forms a product gas including the H₂; and recovering the product gas from the column.

### TECHNICAL FIELD

This disclosure relates to methods and systems of coupling Claus process with carbon dioxide (CO₂) capture using gas hydrate.

### BACKGROUND

Hydrogen sulfide (H₂S) is a reactive and poisonous contaminant that can be found in petroleum and natural gas processing, e.g., produced oil and natural gas as well as wastewater from oil/gas production. H₂S and CO₂ can be primary components in acid gases found in these industrial processes, and the removal of sulfur from the acid gases is an important part of oil and natural gas production and processing. H₂S in the acid gases can be converted to elemental sulfur in a sulfur recovery unit by, for example, a Claus process with by-products including CO₂, hydrogen (H₂), and water (H₂O).

### SUMMARY

This disclosure describes technologies relating to coupling Claus process with carbon dioxide (CO₂) capture using gas hydrate.

### BRIEF DESCRIPTION OF DRAWINGS

FIGS. 1A and 1B are gas hydrate cage structures.

FIG. 2 is a block diagram of Claus-CO₂ capture process with a single gas hydrate column.

FIG. 3 is a block diagram of Claus-CO₂ capture process with two gas hydrate columns.

FIGS. 4A-4B are process flow diagrams of methods of Claus-CO₂ capture process.

### DETAILED DESCRIPTION

Implementations described herein provide the methods and systems of coupling Claus process for sulfur removal from an acid gas and CO₂ capture using gas hydrate, referred to as Claus-CO₂ capture process in this disclosure. Various implementations of Claus-CO₂ capture process can improve the H₂ recovery and CO₂ capture performance by selective CO₂ capture through gas hydrate formation from a tail gas generated in a Claus process. The Claus process is an acid gas treatment to remove sulfur-containing compounds such as H₂S in the acidic gas by converting them into elemental sulfur, e.g., S₈. A typical Claus process reaction involves two steps: oxidation of H₂S to form sulfur dioxide (SO₂) and H₂O, followed by reaction of SO₂ and H₂S to form elemental sulfur and H₂O. The direct splitting of H₂S can also take place, generating H₂. However, the H₂ recovery can be low with technologies currently available for H₂S decomposition. Further, the acid gas also contains CO₂, which should be captured to reduce the carbon footprint of the overall acid gas treatment process. The CO₂ capture after the acid treatment can employ adsorption, absorption and membrane technologies, but they are generally low efficiency and require multiple stages. Therefore, it is desirable to develop a new efficient method of acid gas treatment with improved energy recovery, e.g., H₂ and carbon capture efficiency.

In the Claus-CO₂ capture process described in this disclosure, a Claus process is performed first to treat the acid gas to remove sulfur from the acid gas, followed by gas hydrate formation. The gas hydrate can be formed to selectively capture CO₂ in the Claus tail gas, resulting in a remaining product gas containing a high purity H₂, e.g., 99 mol % or higher. The captured CO₂ in the gas hydrate can be released via hydrate dissociation, and a high purity CO₂, e.g., 99 mol % can be recovered, advantageously enabling the H₂—CO₂ separation via pressure swing mechanism without the need of costly membranes or adsorption systems. The Claus-CO₂ capture process can accordingly offer a cost-effective separation technology coupled with sulfur removal in comparison with amine absorption, CO₂ liquefaction, or H₂-selective membranes. The system for the Claus-CO₂ capture process can include a post-Claus compressor and chiller to realize the pressure and temperature conditions suitable for gas hydrate formation with CO₂, e.g., 30 bar (3 MPa) or higher and 10° C. or lower, respectively.

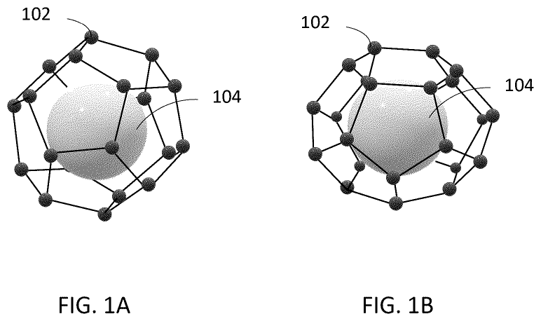

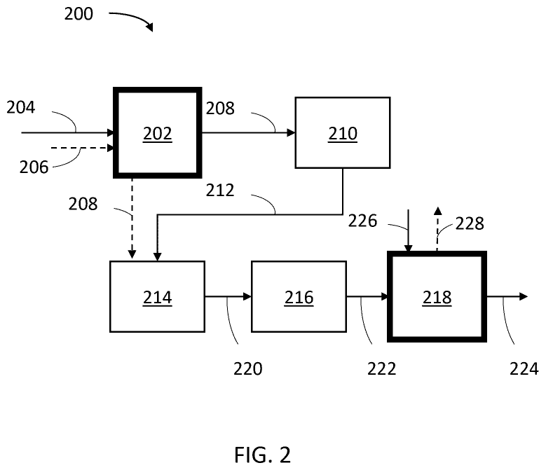

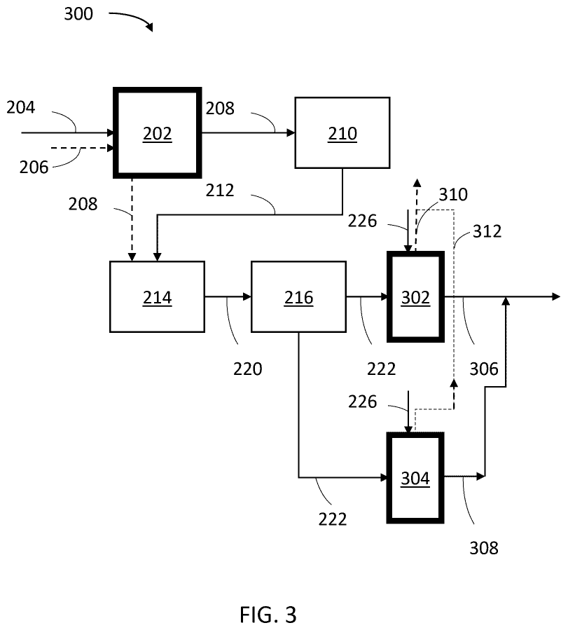

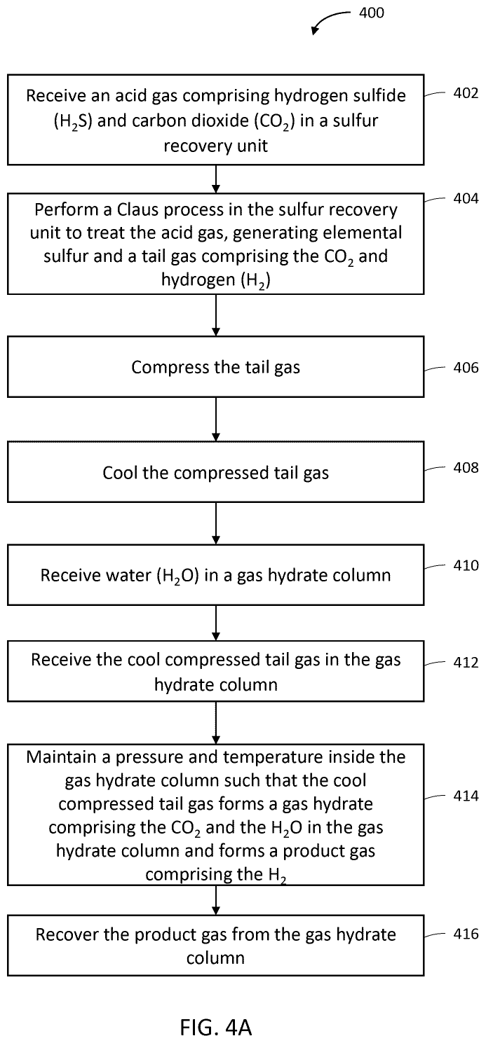

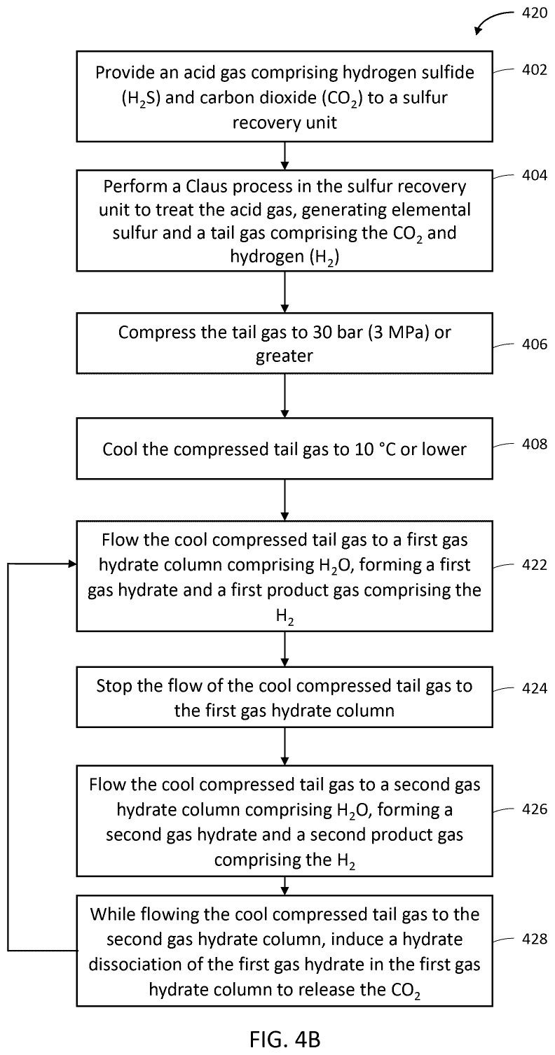

In the following, example cage structures for gas hydrate are first described referring to FIGS. 1A-1B. Methods and systems of Claus-CO₂ capture process in various implementations are described referring to FIGS. 2-3. FIGS. 4A-4B are example process flow diagrams for the method of Claus-CO₂ capture process. In this disclosure, various implementations of CO₂ capture based on CO₂ hydrate are described primarily with examples of H₂—CO₂ separation, but in some implementations, the methods of CO₂ captures can be applied for separation of various other combinations of gases, e.g., N₂—CO₂ separation.

### Gas Hydrate Structure

FIGS. 1A and 1B illustrate a cage structure of a gas hydrate. Gas hydrate, or also known as clathrate hydrate is a class of crystalline material where H₂O molecules forms a hydrogen-bonded crystalline structure with a cage structure that is capable of trapping guest molecules inside. As illustrated in FIGS. 1A and 1B, the host molecules 102, e.g., H₂O molecules in clathrate hydrates, form a crystalline structure with a cage, in which a guest molecule 104, e.g., CO₂, can be trapped. The solid circles of the host molecules 102 in FIGS. 1A and 1B correspond to the position of the oxygen atoms of H₂O, while the hydrogen atoms are omitted in FIGS. 1A and 1B for illustration purpose.

The gas hydrate can have various crystalline structure with different cage geometries such as cubic structures I (sI) and (sII) II and hexagonal structure H. Each crystalline structure can contain different cage structures with varying dimensions, and each cage can typically contain one guest molecule 104. In some implementations, the gas hydrate can have a sI structure, which includes two types of cages: small dodecahedral cage as illustrated in FIG. 1A and large tetradecahedral cages as illustrated in FIG. 1B. The unit cell of a sI-type gas hydrate consists of 46 H₂O molecules, which makes up two small dodecahedral cages (FIG. 1A) and six large tetradecahedral cages (FIG. 1B). Accordingly, each of FIGS. 1A and 1B only represents a portion of the unit cell of the sI-type gas hydrate. In some implementations, the maximum guest-to-host ratio (e.g., CO₂ -to-H₂O) in this structure is about 1:5.75 with an ideal chemical formula of CO₂·nH₂O (n=5.75).

Gas hydrate materials found in nature, e.g., methane gas hydrate, can be used as a potential energy source to extract hydrocarbons. Gas hydrates can also find various applications in gas production, separation, and storage. For example, hydrate-based storage and transportation systems can offer a high-density storage and transportation of natural gas. The Claus-CO₂ capture process in this disclosure uses CO₂ hydrate as a means of CO₂ capture and H₂ purification following a Claus process for sulfur removal. In some implementations, the formation of CO₂ hydrate becomes possible at about 10° C. or lower, and the stability of the CO₂ hydrate depends on the pressure-temperature condition, where a higher pressure generally favors its stability. Accordingly, the method of Claus-CO₂ capture process involves controlling the pressure and temperature of the Claus tail gas to enable and enhance the formation of CO₂ hydrate.

### Sulfur Removal in Claus-CO₂ Capture Process

FIG. 2 is a block diagram of Claus-CO₂ capture process 200 with a single gas hydrate column. Solid arrows are used in FIG. 2 to indicate gas or liquid flows, e.g., inflow and outflow, possible during the Claus-CO₂ capture process. First, in FIG. 2, a sulfur recovery unit (SRU) 202 receives an acid gas 204 including H₂S and CO₂. The source of the acid gas 204 includes various oil and natural gas processing processes.

In some implementations, the acid gas 204 can include a gas isolated by amine gas treatment of a process gas or product gas generated in a refinery, a petrochemical plant, or a natural gas processing plant. For example, a hydrocarbon stream that includes H₂S and CO₂ can be treated using an amine aqueous solution to capture H₂S and CO₂ in the solution. The spent amine aqueous solution may be processed in an amine recovery unit (ARU), not shown, for regeneration to release the captured H₂S and CO₂, which generates the acid gas free of the hydrocarbon. Accordingly, the SRU 202 can be connected to the ARU to receive the acid gas 204.

The acid gas 204 can also be from a sour water that is generated as a wastewater from a refinery or a produced water. In some implementations, the acid gas 204 can be generated from a stripping process of a sour water including H₂S and ammonia (NH₃). The sour water stripping process can include, but not limited to, nitrogen (N₂) purging, pH changing via acid addition, thermal stripping and any combination of thereof. In some embodiments, an acid such as sulfuric acid can be used to lower the pH and thereby also lower the H₂S solubility in the sour water to improve its removal. Heat can also be provided for better stripping. In some embodiments, instead of or in addition to gas purging, a vacuum can be used to lower the pressure in the sour water stripper. Accordingly, the SRU 202 can be connected to the sour water stripper to receive the acid gas 204. Although not specifically illustrated in FIG. 2, in some implementations, the acid gas 204 to be sent to the SRU 202 can be from multiple sources.

The acid gas 204 can contain a water vapor and its concentration can depend on the source and the stripping conditions. In some embodiments, the acid gas 204 is saturated with the water vapor. In one embodiment, the acid gas 204 contains 1-10% water vapor. The acid gas 204 can be primarily H₂S and CO₂, e.g., about 40 mol % to about 80 mol % H₂S and about 15 mol % to about 55 mol % CO₂. In one implementation, the acid gas 204 contains about 60 mol % H₂S and about 35 mol % CO₂.

In the SRU 202, a Claus process can be performed to convert H₂S in the acid gas 204. In some implementations, an additional gas feed 206, e.g., oxygen (O₂) or air, can be fed to the SRU 202, for example, to increase the reactor temperature and enhance the oxidation. Possible reactions pathways for H₂S include partial oxidation (Reaction 1, also referred to as R1), Claus reaction (Reaction 2, also referred to as R2), and direct splitting (Reaction 3, also referred to as R3).

2H₂S+3O₂→2SO₂+2H₂O (R1)

4H₂S+2SO₂→3S₂+4H₂O (R2)

2H₂S→2H₂+S₂ (R3)

Although not specifically illustrated in FIG. 2, the SRU 202 can include multiple reactors to carry out different reactions including R1-3 for the purpose of sulfur removal. In some implementations, the acid gas 204 can be first sent to a combustion chamber for the oxidation stage (R1) and the direct splitting (R3). This stage of the Claus process can be performed at a high temperature between about 850° C. and about 1200° C., e.g., above 1050° C. By maintaining a sufficiently high temperature at this stage, other contaminants present in the acid gas 204, e.g., mercaptans, carbonyl sulfide, carbon disulfide, benzene, toluene, and xylene can be eliminated. The process condition for the first stage can be adjusted based on the composition of the acid gas 204, e.g., the H₂S concentration.

Following the first stage, the Claus reaction (R2) can be performed in a catalytic convertor. Examples of the catalyst for the Claus reaction include activated aluminum oxide and titanium oxide. This second stage of the Claus process can be performed at a temperature lower than the first stage, e.g., between about 200° C. and 330° C. In one implementation, the temperature of the catalytic converter can be about 305° C. Further, the Claus reaction can be performed using more than one catalytic convertor operating at different process conditions, e.g., temperatures.

The Claus process in the SRU 202 generates the elemental sulfur and a Claus tail gas 208 containing CO₂, H₂, H₂O, and other components such as SO₂ and CO. In some implementations, the Claus tail gas 208 can contain a residual H₂S between about 1 mol % and about 5 mol %, e.g., at about 3.0 mol %. The CO₂ concentration in the Claus tail gas 208 can be, for example, about 10 mol % and about 50 mol %.

In some implementations, the Claus process in the SRU 202 can be controlled to maximize the H₂ yield in addition to the sulfur removal from the gas phase. The H₂ yield can be increased by adjusting process parameters, for example, by using high concentration or pure O₂ gas stream for the additional gas feed 206 instead of the air. Further, in one implementation, a porous burner can be used to improve the heat distribution of the process for better H₂ yield.

The Claus tail gas 208 can subsequently be sent to a tail gas treatment unit (TGTU) 210 to further reduce the sulfur content in the gas stream prior to CO₂ capture with gas hydrate. The use of the TGTU 210 can enable the sulfur recovery at 99.9% or higher. After the tail gas treatment, a TGTU tail gas 212 containing even less H₂S than the Claus tail gas 208, e.g., 200 parts per million (ppm) or less, can be sent to a compressor 214 for the CO₂ capture stage. In some implementations, the TGTU tail gas 212 can contain from about 60 mol % to about 80 mol % CO₂ and from about 10 mol % to about 20 mol % H₂. The TGTU 210 can be optional and omitted from the Claus-CO₂ capture process, where the Claus tail gas 208 can be sent directly to the compressor 214 in some implementations as indicated by a dotted arrow.

Examples of tail gas treatment includes (1) sub-dew point Claus process, (2) direct oxidation of residual H₂S to sulfur, (3) Reduction followed by H₂S recovery, and (4) H₂S combustion to SO₂ followed by SO₂ recovery, as summarized below.

Sub-dew point Claus processes are based on a Claus converter performing at temperatures below the sulfur dew point. Sub-dew point processes can provide high equilibrium conversions in one catalyst bed but are complicated by the need for periodic catalyst regeneration by sulfur evaporation at elevated temperatures. To accommodate for regeneration, such processes are usually performed in two, three, or more parallel reactors, periodically undergoing reaction and regeneration.

Direct oxidation of H₂S to sulfur are based on selective oxidation of H₂S by O₂ to elemental sulfur, generating H₂O as by-product using selective catalysts. Examples of the selective catalysts can include metal or metal oxide catalysts.

Reduction followed by recovery of H₂S involves the catalytic hydrogenation of residual sulfur species such as SO₂, carbon disulfide (CS₂), and carbonyl sulfide (COS), to H₂S, absorption of the H₂S with amine solution, and then recycling the H₂S back to the SRU 202. Accordingly, in one or more implementations, the TGTU 210 includes an amine scrubber to capture H₂S.

H₂S combustion to SO₂ followed by recovery of SO₂ involves the combustion of residual H₂S in the Claus tail gas 208 to SO₂, absorption of SO₂ with a solvent, and recycling the SO₂ back to be added to the acid gas 204.

### CO₂ Capture in Claus-CO₂ Capture Process

To enable a phase of CO₂ hydrate at the CO₂ capture stage, the temperature and pressure of the process gas, e.g., the TGTU tail gas 212, need to be controlled. As illustrated in FIG. 2, the TGTU tail gas 212 can be first sent to the compressor 214 for compression, a chiller 216 for cooling, and then to a gas hydrate column 218, in which the CO₂ hydrate can be precipitated.

In some implementations, the TGTU tail gas 212 has a pressure of about 1 bar (0.1 MPa) and a temperature of about 45° C., and the compressor 214 compresses the TGTU tail gas 212 to form a compressed tail gas 220 having a pressure of about 30 bar (3 MPa) or higher, e.g., about 40 bar (4 MPa). Further, the chiller can cool down the compressed tail gas 220 to 10° C. or lower, e.g., about 8° C. Subsequently, a cool compressed tail gas 222 ejected from the chiller 216 can be sent to the gas hydrate column 218.

The gas hydrate column 218 can be any column suitable for precipitating the CO₂ hydrate and capable of ejecting a product gas 224 containing H₂. In some implementations, the gas hydrate column 218 can include one or more trays inside, where each tray can act as a surface for the precipitation.

H₂O is needed as the host molecules for CO₂ hydrate formation. The cool compressed tail gas 222 can contain some H₂O carried from the TGTU tail gas 212. In various implementations, the method of Claus-CO₂ capture process can include providing additional H₂O 226, in addition to the cool compressed tail gas 222, to the gas hydrate column 218. For example, at the beginning of the CO₂ capture stage, the additional H₂O 226 can be sprayed from the top portion of the gas hydrate column 218. The additional H₂O 226 can be spread on each tray inside the gas hydrate column 218. Further, in some implementations, the additional H₂O 226 can be provided as a brine solution. To enhance gas hydrate formation, a gas hydrate inducer can also be provided to the gas hydrate column 218. The gas hydrate inducer can affect the kinetics, thermodynamics, or both of the gas hydrate formation and thereby hydrate stability. Examples of the gas hydrate inducer include inorganic salts, e.g., sodium chloride (NaCl), surfactants, e.g., sodium dodecyl sulfate, and solid particles, e.g., silica nanoparticles.

With the adequate temperature and pressure control, the CO₂ hydrate can form in the gas hydrate column 218, capturing CO₂ in the cool compressed tail gas 222. In some implementations, the cool compressed tail gas 222 can contain other gas components such as residual H₂S at trace level, e.g., 200 ppm or less, and such gas components may also be captured in the gas hydrate, except H₂ component. The molecular size of H₂ is too small to be captured by the cage structure of the gas hydrate, and thereby H₂ remains in the gas phase as the product gas 224. The product gas 224 can contain a high purity H₂, e.g., 99 mol % or higher. The high purity H₂ can be sent to another processing as a fuel or a feed gas, or stored in underground storage or surface storage for further use.

### CO₂ Release by Hydrate Dissociation

The method of Claus-CO₂ capture process can further include releasing the captured CO₂ to recover a concentrated CO₂ stream and regenerate the gas hydrate column 218. For example, once the gas hydrate column 218 is saturated, e.g., when H₂O is depleted and no more hydrate formation occurs, the flow of the cool compressed tail gas 222 to the gas hydrate column 218 can be stopped. Subsequently, the captured CO₂ can be released into a gas phase via hydrate dissociation. During hydrate dissociation, the thermodynamic conditions for the stable gas hydrate can be broken, for example, by reducing the column internal pressure, increasing the column internal temperature, or both.

Hydrate dissociation can release a substantially large volume of gas that was trapped inside the hydrate. For example, the volume of CO₂ released can be up to 175 times the volume of the CO₂ hydrate. The condition for hydrate dissociation can be controlled such that H₂O does not evaporate and a CO₂ gas 228 at a high concentration, e.g., 99 mol % or higher. Accordingly, the additional H₂O 226 and H₂O carried in the cool compressed tail gas 222 can remain in the gas hydrate column 218 during the CO₂ release stage. In some implementations, a minor loss of H₂O, e.g., 10 mol % of the initial amount or less, may occur, and H₂O can be replenished during the cycles of Claus-CO₂ capture process.

In some implementations, the CO₂ gas 228 can be ejected from the same outlet of the gas hydrate column 218 used for the product gas 224, while their ejections are temporarily separated. The CO₂ gas 228 can be then sent to a sequestration or storage facility such as underground reservoir. Compared to the other available CO₂ capture technologies such as adsorption, amine absorption, membrane separation, the method of Claus-CO₂ capture process can reduce the number of process steps, e.g., removing molecular sieve dehydration, amine absorption, CO₂ refrigeration and liquefaction, and solvent recovery. Further, the method in various implementations allow the H₂ purification form the Claus tail gas 208 without the requirement of pressure swing H₂ recovery. Accordingly, the method of Claus-CO₂ capture process can improve the CO₂ recovery efficiency and the energy cost of the sulfur treatment processes.

### Multiple Gas Hydrate Columns for Claus-CO₂ Capture Process

In some implementations, the CO₂ capture stage by gas hydrate can be performed using more than one gas hydrate column. FIG. 3 is another block diagram of Claus-CO₂ capture process 300 with two gas hydrate columns: a first gas hydrate column 302 and a second gas hydrate column 304. Like numbered items are as described with respect to FIG. 2. With the use of two gas hydrate columns, a continuous processing of the Claus tail gas and simultaneous CO₂ release with column regeneration are enabled as further described below. Although not specifically illustrated in FIG. 2 or 3, it is possible to apply any number of gas hydrate columns for improving the process throughput and continuity.

In FIG. 3, the Claus process, tail gas treatment, compression, and cooling can be performed as described above referring to FIG. 2. An acid gas 204 containing H₂S and CO₂ can be processed by a sulfur recovery unit (SRU) 202 for sulfur removal, a tail gas treatment unit (TGTU) 210 for further sulfur removal, a compressor 214, and a chiller 216. A cool compressed tail gas 222 can then be subject to CO₂ capture. In these implementations, the method can first proceed to flowing the cool compressed tail gas 222 to the first gas hydrate column 302 that contains H₂O. As described above in prior implementations, a CO₂ hydrate can be formed in the first gas hydrate column 302, selectivity capturing CO₂ from the cool compressed tail gas 222. A first product gas 306 containing H₂ can be ejected and recovered as a high purity H₂, e.g., 99 mol % or higher.

The flow of the cool compressed tail gas 222 can be then switched from the first gas hydrate column 302 to the second gas hydrate column 304. Accordingly, the cool compressed tail gas 222 can be sent to either one of the two gas hydrate columns at a time, although it is possible, in one or more implementations, to flow the cool compressed tail gas 222 to more than one gas hydrate column at the same time. In some implementations, the flow can be switched once the first gas hydrate column 302 is saturated and no further hydrate formation occurs in the first gas hydrate column 302. Another CO₂ hydrate can be formed in the second gas hydrate column 304. A second product gas 308 containing H₂ can be ejected and recovered as a high purity H₂, e.g., 99 mol % or higher. In some implementations, the first product gas 306 and the second product gas 308 can be merged into one gas stream for further processing or storage.

In various implementations, the flow of the cool compressed tail gas 222 can be repeatedly switched between the two columns using a flow controller. The alternating use of the two gas hydrate columns advantageously allows the simultaneous regeneration of the gas hydrate columns. For example, while flowing the cool compressed tail gas 222 to the second gas hydrate column 304, the regeneration of the first gas hydrate column 302 and CO₂ release can be performed by inducing a hydrate dissociation. As previously described, the hydrate dissociation can be induced by reducing the column internal pressure, increasing the column internal temperature, or both. A first CO₂ gas 310 can be recovered. In the same way, the second gas hydrate column 304 can be regenerated to release a second CO₂ gas 312 while flowing the cool compressed tail gas 222 to the first gas hydrate column 302. In some implementations, the first CO₂ gas 310 and the second CO₂ gas 312 can be merged into one gas stream for further processing or sequestration.

FIGS. 4A-4B are example process flow diagrams of methods of Claus-CO₂ capture process using gas hydrate. In FIG. 4A, a method 400 according to an implementation starts with receiving 402 an acid gas including hydrogen sulfide (H₂S) and carbon dioxide (CO₂) in a sulfur recovery unit, followed by performing 404 a Claus process in the sulfur recovery unit to treat the acid gas, where the Claus process generates elemental sulfur and a tail gas including CO₂ and hydrogen (H₂). Subsequently, the tail gas is compressed 406, e.g., to 30 bar (3 MPa) or higher, and cooled 408, e.g., to 10° C. or lower. The method 400 then proceeds to receiving 410 water (H₂O) in a gas hydrate column, followed by receiving 412 the cool compressed tail gas in the gas hydrate column. In the gas hydrate column, the cool compressed tail gas reacts with the H₂O and forms a gas hydrate including CO₂ and H₂O and a product gas including H₂. To enable the gas hydrate formation, a pressure and a temperature inside the gas hydrate column can be maintained 414 at appropriate conditions, e.g., at 30 bar (3 MPa) or higher and at 10° C. or lower, respectively. The product gas can then be recovered 416 from the gas hydrate column.

In FIG. 4B, a method 420 according to another implementation starts with providing 402 an acid gas including hydrogen sulfide (H₂S) and carbon dioxide (CO₂) to a sulfur recovery unit, followed by performing 404 a Claus process in the sulfur recovery unit to treat the acid gas, where the Claus process generates elemental sulfur and a tail gas including CO₂ and hydrogen (H₂). Subsequently, the tail gas is compressed 406 to 30 bar (3 MPa) or higher and cooled 408 to 10° C. or lower. The cool compressed tail gas is then flowed 422 to a first gas hydrate column including water (H₂O). In the first gas hydrate column, the cool compressed tail gas forms a gas hydrate including CO₂ and H₂O and a product gas including H₂. The method 420 further proceeds to stopping 424 the flow of the cool compressed tail gas to the first gas hydrate column, followed by flowing 426 the cool compressed tail gas to a second gas hydrate column including H₂O, where the gas hydrate formation occurs in the same way as in the first gas hydrate column. While flowing the cool compressed tail gas to the second gas hydrate column, a hydrate dissociation of the first gas hydrate can be induced 248 in the first gas hydrate column to release the CO₂.

### Implementations

An implementation described herein provides a method of processing an acid gas that includes: receiving, in a sulfur recovery unit, an acid gas including hydrogen sulfide (H₂S) and carbon dioxide (CO₂); performing, in the sulfur recovery unit, a Claus process to treat the acid gas, generating elemental sulfur and a tail gas including the CO₂ and hydrogen (H₂); compressing the tail gas to form a compressed tail gas; cooling the compressed tail gas to form the cool compressed tail gas; receiving water (H₂O) in a gas hydrate column; receiving the cool compressed tail gas in the gas hydrate column; maintaining, while receiving the cool compressed tail gas in the gas hydrate column, a pressure and a temperature inside the gas hydrate column such that the cool compressed tail gas reacts with the H₂O to form a gas hydrate including the CO₂ and the H₂O in the gas hydrate column and forms a product gas including the H₂; and recovering the product gas from the gas hydrate column.

In an aspect, combinable with any other aspect, the cool compressed tail gas has a pressure of 30 bar (3 MPa) or higher and a temperature of 10° C. or lower.

In an aspect, combinable with any other aspect, while receiving the cool compressed tail gas in the gas hydrate column, the pressure and the temperature inside the gas hydrate column is maintained at 30 bar (3 MPa) or higher and 10° C. or lower, respectively.

In an aspect, combinable with any other aspect, the method further includes forming the acid gas by: performing amine gas treatment using an amine aqueous solution to capture the H₂S and the CO₂ from a gas generated in a refinery, a petrochemical plant, or a natural gas processing plant; and releasing the H₂S and the CO₂ from the amine aqueous solution, generating the acid gas.

In an aspect, combinable with any other aspect, the method further includes forming the acid gas by performing a stripping process of a sour water including the H₂S and ammonia (NH₃), the sour water being generated as a wastewater from a refinery.

In an aspect, combinable with any other aspect, the Claus process includes: providing oxygen (O₂) to the sulfur recovery unit; reacting the O₂ with a portion of the H₂S to form sulfur dioxide (SO₂) and H₂O; reacting the SO₂ with another portion of the H₂S to form the elemental sulfur and H₂O.

In an aspect, combinable with any other aspect, the tail gas prior to the compressing includes a residual H₂S at a concentration between 1 mol % and 5 mol %, and the method further includes, prior to the compressing, reducing the concentration of the residual H₂S to 200 parts per million (ppm) or less.

In an aspect, combinable with any other aspect, the H₂O to the gas hydrate column is provided by spraying of the H₂O.

In an aspect, combinable with any other aspect, the method further includes, after recovering the product gas from the gas hydrate column, inducing a hydrate dissociation of the gas hydrate in the gas hydrate column to release the CO₂ form the gas hydrate, the inducing including reducing the pressure inside the gas hydrate column.

In an aspect, combinable with any other aspect, the method further includes, after recovering the product gas from the gas hydrate column, inducing a hydrate dissociation of the gas hydrate in the gas hydrate column to release the CO₂ form the gas hydrate, the inducing including increasing the temperature inside the gas hydrate column.

In an aspect, combinable with any other aspect, the method further includes, after recovering the product gas from the gas hydrate column, inducing a hydrate dissociation of the gas hydrate in the gas hydrate column to release a gas including at least 99 mol % CO₂, and wherein the product gas includes at least 99 mol % H₂.

An implementation described herein provides a method of processing an acid gas that includes: providing an acid gas including hydrogen sulfide (H₂S) and carbon dioxide (CO₂) to a sulfur recovery unit; performing a Claus process in the sulfur recovery unit to treat the acid gas, generating elemental sulfur and a tail gas including the CO₂ and hydrogen (H₂); compressing the tail gas to 30 bar (3 MPa) or higher; cooling the compressed tail gas to 10° C. or lower; flowing the cool compressed tail gas to a first gas hydrate column including water (H₂O), the cool compressed tail gas forming a first gas hydrate including the CO₂ and the H₂O in the first gas hydrate column, forming a first product gas including the H₂; stopping the flow of the cool compressed tail gas to the first gas hydrate column; flowing the cool compressed tail gas to a second gas hydrate column including H₂O, the cool compressed tail gas forming a second gas hydrate including the CO₂ and the H₂O in the second gas hydrate column, forming a second product gas including the H₂; and while flowing the cool compressed tail gas to the second gas hydrate column, inducing a hydrate dissociation of the first gas hydrate in the first gas hydrate column to release the CO₂.

In an aspect, combinable with any other aspect, the method further includes alternately repeating the steps of flowing the cool compressed tail gas to the first gas hydrate column and flowing the cool compressed tail gas to the second gas hydrate column.

In an aspect, combinable with any other aspect, the method further includes, while flowing the cool compressed tail gas to the first gas hydrate column, inducing a hydrate dissociation of the second gas hydrate in the second gas hydrate column to release the CO₂.

An implementation described herein provides a system for processing an acid gas that includes: a sulfur recovery unit capable of performing a Claus process of an acid gas including hydrogen sulfide (H₂S) and carbon dioxide (CO₂) and generating a tail gas including a tail gas including the CO₂ and hydrogen (H₂); a compressor to compress the tail gas to 30 bar (3 MPa) or higher; a chiller to cool the tail gas to a temperature of 10° C. or lower; a first gas hydrate column disposed downstream of the compressor and the chiller, the first gas hydrate column being capable of receiving the cool compressed tail gas from the chiller, forming a first gas hydrate including the CO₂ from the cool compressed tail gas, and forming a first product gas including the H₂; and a second gas hydrate column disposed downstream of the compressor and the chiller, the second gas hydrate column capable of the first gas hydrate column being capable of receiving the cool compressed tail gas, forming a second gas hydrate including the CO₂ from the cool compressed tail gas, and forming a second product gas including the H₂, wherein the first and second gas hydrate columns can withstand a pressure up to 100 bar (10 MPa).

In an aspect, combinable with any other aspect, the system further includes a tail gas treatment unit (TGTU) disposed between the sulfur recovery unit and the compressor, the TGTU being capable of reducing a content of a residual H₂S in the tail gas after the Claus process.

In an aspect, the TGTU includes an amine scrubber.

In an aspect, combinable with any other aspect, the first gas hydrate column includes a first outlet capable of ejecting the product gas, and during a hydrate dissociation stage, ejecting the CO₂.

In an aspect, combinable with any other aspect, the system further includes a flow controller capable of switching a flow of the cool compressed tail gas between to the first gas hydrate column and to the second gas hydrate column.

In an aspect, combinable with any other aspect, the system further includes a pressure controller capable of reducing a pressure inside the first gas hydrate column.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A method of processing an acid gas, the method comprising:
receiving, in a sulfur recovery unit, an acid gas comprising hydrogen sulfide (H₂S) and carbon dioxide (CO₂);
performing, in the sulfur recovery unit, a Claus process to treat the acid gas, generating elemental sulfur and a tail gas comprising the CO₂ and hydrogen (H₂);
compressing the tail gas to form a compressed tail gas;
cooling the compressed tail gas to form the cool compressed tail gas;
receiving water (H₂O) in a gas hydrate column;
receiving the cool compressed tail gas in the gas hydrate column;
maintaining, while receiving the cool compressed tail gas in the gas hydrate column, a pressure and a temperature inside the gas hydrate column such that the cool compressed tail gas reacts with the H₂O to form a gas hydrate comprising the CO₂ and the H₂O in the gas hydrate column and forms a product gas comprising the H₂; and
recovering the product gas from the gas hydrate column.

2. The method of claim 1, wherein the cool compressed tail gas has a pressure of 30 bar (3 MPa) or higher and a temperature of 10° C. or lower.

3. The method of claim 1, wherein, while receiving the cool compressed tail gas in the gas hydrate column, the pressure and the temperature inside the gas hydrate column is maintained at 30 bar (3 MPa) or higher and 10° C. or lower, respectively.

4. The method of claim 1, further comprising forming the acid gas by:
performing amine gas treatment using an amine aqueous solution to capture the H₂S and the CO₂ from a gas generated in a refinery, a petrochemical plant, or a natural gas processing plant; and
releasing the H₂S and the CO₂ from the amine aqueous solution, generating the acid gas.

5. The method of claim 1, further comprising forming the acid gas by performing a stripping process of a sour water comprising the H₂S and ammonia (NH₃), the sour water being generated as a wastewater from a refinery.

6. The method of claim 1, wherein the Claus process comprises:
providing oxygen (O₂) to the sulfur recovery unit;
reacting the O₂ with a portion of the H₂S to form sulfur dioxide (SO₂) and H₂O;
reacting the SO₂ with another portion of the H₂S to form the elemental sulfur and H₂O.

7. The method of claim 1, wherein the tail gas prior to the compressing comprises a residual H₂S at a concentration between 1 mol % and 5 mol %, the method further comprising, prior to the compressing, reducing the concentration of the residual H₂S to 200 parts per million (ppm) or less.

8. The method of claim 1, wherein the providing the H₂O to the gas hydrate column is by spraying of the H₂O.

9. The method of claim 1, further comprising, after recovering the product gas from the gas hydrate column, inducing a hydrate dissociation of the gas hydrate in the gas hydrate column to release the CO₂ form the gas hydrate, the inducing comprising reducing the pressure inside the gas hydrate column.

10. The method of claim 1, further comprising, after recovering the product gas from the gas hydrate column, inducing a hydrate dissociation of the gas hydrate in the gas hydrate column to release the CO₂ form the gas hydrate, the inducing comprising increasing the temperature inside the gas hydrate column.

11. The method of claim 1, further comprising, after recovering the product gas from the gas hydrate column, inducing a hydrate dissociation of the gas hydrate in the gas hydrate column to release a gas comprising at least 99 mol % CO₂, and wherein the product gas comprises at least 99 mol % H₂.

12. A method of processing an acid gas, the method comprising:
providing an acid gas comprising hydrogen sulfide (H₂S) and carbon dioxide (CO₂) to a sulfur recovery unit;
performing a Claus process in the sulfur recovery unit to treat the acid gas, generating elemental sulfur and a tail gas comprising the CO₂ and hydrogen (H₂);
compressing the tail gas to 30 bar (3 MPa) or higher;
cooling the compressed tail gas to 10° C. or lower;
flowing the cool compressed tail gas to a first gas hydrate column comprising water (H₂O), the cool compressed tail gas forming a first gas hydrate comprising the CO₂ and the H₂O in the first gas hydrate column, forming a first product gas comprising the H₂;
stopping the flow of the cool compressed tail gas to the first gas hydrate column;
flowing the cool compressed tail gas to a second gas hydrate column comprising H₂O, the cool compressed tail gas forming a second gas hydrate comprising the CO₂ and the H₂O in the second gas hydrate column, forming a second product gas comprising the H₂; and
while flowing the cool compressed tail gas to the second gas hydrate column, inducing a hydrate dissociation of the first gas hydrate in the first gas hydrate column to release the CO₂.

13. The method of claim 12, the method further comprising alternately repeating the steps of flowing the cool compressed tail gas to the first gas hydrate column and flowing the cool compressed tail gas to the second gas hydrate column.

14. The method of claim 13, further comprising, while flowing the cool compressed tail gas to the first gas hydrate column, inducing a hydrate dissociation of the second gas hydrate in the second gas hydrate column to release the CO₂.

15. A system for processing an acid gas comprising:
a sulfur recovery unit capable of performing a Claus process of an acid gas comprising hydrogen sulfide (H₂S) and carbon dioxide (CO₂) and generating a tail gas comprising a tail gas comprising the CO₂ and hydrogen (H₂);
a compressor to compress the tail gas to 30 bar (3 MPa) or higher;
a chiller to cool the tail gas to a temperature of 10° C. or lower;
a first gas hydrate column disposed downstream of the compressor and the chiller, the first gas hydrate column being capable of receiving the cool compressed tail gas from the chiller, forming a first gas hydrate comprising the CO₂ from the cool compressed tail gas, and forming a first product gas comprising the H₂; and
a second gas hydrate column disposed downstream of the compressor and the chiller, the second gas hydrate column capable of the first gas hydrate column being capable of receiving the cool compressed tail gas, forming a second gas hydrate comprising the CO₂ from the cool compressed tail gas, and forming a second product gas comprising the H₂,
wherein the first and second gas hydrate columns can withstand a pressure up to 100 bar (10 MPa).

16. The system of claim 15, further comprising a tail gas treatment unit (TGTU) disposed between the sulfur recovery unit and the compressor, the TGTU being capable of reducing a content of a residual H₂S in the tail gas after the Claus process.

17. The system of claim 16, wherein the TGTU comprises an amine scrubber.

18. The system of claim 15, wherein the first gas hydrate column comprises a first outlet capable of ejecting the product gas, and during a hydrate dissociation stage, ejecting the CO₂.

19. The system of claim 15, further comprising a flow controller capable of switching a flow of the cool compressed tail gas between to the first gas hydrate column and to the second gas hydrate column.

20. The system of claim 15, further comprising a pressure controller capable of reducing a pressure inside the first gas hydrate column.
